(19) United States
(12) Patent Application Publication
(10) Pub. No.: US 2026/0121393 A1
(43) Pub. Date: Apr. 30, 2026

(54) SPOOLABLE SPLICE FOR USE IN ELECTRICAL SUBMERSIBLE PUMP SYSTEM

(71) Applicant: Alkhorayef Petroleum Company, Dammam (SA)

(72) Inventors: Serko Sarian, Dammam (SA); Kartikkumar Jaysingbhai Gohil, Houston, TX (US); Santos Daniel Ortiz, Houston, TX (US)

(21) Appl. No.: 18/930,299

(22) Filed: Oct. 29, 2024

(51) Int. Cl. H02G 15/24

(52) U.S. Cl. CPC H02G 15/24

(57) ABSTRACT

Systems and methods are provided for improved installation speed and reliability for mechanical cable splices to safely retrieve an armored electrical cable and attached electrical submersible pump (ESP) from a wellbore. The ESP can be brought to the surface for replacement or maintenance and reinstallation along with the same armored power cable. Embodiments of cable splice devices are provided to establish a strong splice having tensile strength required or exceeding that needed to retrieve the cable and ESP from the wellbore safely. A bypass load-bearing clamp may be used temporarily to further assist the tensile strength of the cable non-electrical splice if such tensile strength is deemed insufficient to safely overcome the required retrieval forces. Furthermore, the splice includes a short-circuit electrical connector that enables a quick electrical continuity test for determining if the cable is suitable for redeployment.

### FIELD

The technology disclosed herein relates to a splice for a power cable for a submersible pump, in particular for a spoolable splice for a cable for an electrical submersible pump for use in a wellbore.

### BACKGROUND

Electrical submersible pump (ESP) systems are a type of artificial lift system used in oil and gas wells to increase the flow of fluids (such as water and/or oil) to the surface. An ESP generally includes a pump that is submerged in the wellbore and is powered by a downhole electric motor. The ESP system is designed to operate under high temperatures, pressures, and corrosive conditions, making it suitable for use in harsh downhole environments.

ESPs may be installed in a wellbore with a landing assembly to improve production. Installing, replacing, or repairing an ESP requires significant time and cost in preparing the wellbore to perform the installation or change out operation, lasting days and even weeks at times. Among the many operations needed are “killing the well,” consisting of pumping heavy fluids in the well to prevent uncontrolled well fluids spill at surface, and the spudding of a workover rig to remove the complete production assembly at the end of which the ESP is connected. Often the preparation for servicing the ESP or removing the landing equipment involves even more time than the time to replace or repair the ESP.

ESPs require a heavy armored cable to supply power to the ESP, which can be thousands of feet in length. This armored cable and the personnel time to remove and replace it is also valuable. Thus, a fast and accurate system and method for removing, testing, and redeploying the valuable armored cable line is desirable.

### SUMMARY

The following is a brief summary of subject matter that is described in greater detail herein. This summary is not intended to be limiting as to the scope of the claims.

Improvements in ESP maintenance and replacement speed and cost can be realized without the need to kill the well or dispose of the armored cable for the ESP. Further improvements can be achieved by using the spliced power cable in a spool to retrieve the ESP, test the ESP prior to replacing it in the well and then re-deploying the same cable or deploying an operable reused cable back into the well with a new or repaired ESP.

An exemplary operation entails the use of a power cable mechanical splice, while retrieving the power cable and the ESP from the wellbore in the event of an ESP or power cable failure or any other wellbore related issues preventing the use of the ESP. Due to the cable movement path through the equipment above the well (gripper units and strippers), physical restrictions inside the deployment-retrieval apparatus and the pressure control equipment (packoffs in stripper unit), the splice needs to be about the same diameter as the cable (or less) and of a length not exceeding seven inches (7″) to allow for correct spooling of the power cable on the surface deployment reel available at the wellsite. This is a challenge to also sustain safely the tensile loads needed for the power cable retrieval operation, mainly the weight of the power cable and the ESP deployed in the wellbore at the required depth. Often this depth may be up to 15,000 ft and tensile loads on the splice (due to the weight of the armored cable and ESP) may approach 25,000 lbs.

In some aspects, an exemplary power cable splice is disposed on a mechanical termination of a first cable at least partially wound on a surface reel. The cable electrical core is first trimmed back no less than 3 inches at either end of the cables The splice is then joined to the terminal end of the first cable with a right hand or left hand turn first threaded coupling. The splice is also joined to a terminal end of a second cable, e.g., a cable disposed in a wellbore with a second coupling having the opposite turn thread from the first coupling. In an embodiment, a three-conductor brass short-circuit connector is installed at the terminal end of the second cable in the wellbore and a threaded connector cylinder is coupled to the first and second couplings is installed to connect the first and second cable terminations and create the splice.

Another representation of a splice includes a swage of the same diameter as the first and second cable that is in a cylindrical form short-enough to follow the cable on the reel based on the curvature of the core of the reel, e.g., seven inches long or less, where both ends of the cables are inserted after removing the electrical components and then swaged to provide frictional grip to both ends and create a non-electrical splice. A three-conductor electrical short connector is installed on the second cable section in the well to terminate electrical conductors.

In some aspects, the techniques described herein relate to a method of retrieving an electrical submersible pump system in a wellbore, the method including: installing a non-electrical splice to connect a cable section above the wellbore spooled on a surface reel to a cable section inside the wellbore, preparing both ends of the cable for the installation of the splice, connecting both ends of the cable using a threaded connector or a swage cylinder after the installation of a three-conductor electrical connector to the second cable end (wellbore side). Then pull testing splice connection and ensuring the connection will safely hold the required weight of the cable section and the ESP in the wellbore. Then the well-pressure control equipment is closed over the non-electrical splice to contain wellbore fluids and pressure when the wellbore sealing valve is opened to allow free movement of the cable upwards, initiating the slow upward movement of the cable. The passage of the splice through the cable restrictions is monitored. These restrictions include, e.g., a cable stripper and a coiled tubing injector head fitted with cable specific traction grippers providing cable movement in and out of the well. Furthermore, the monitoring is performed of the spooling of the splice onto the cable reel at the coiled tubing deployment unit located near the wellbore. Once all the cable is spooled on the reel, the ESP is at the surface and the cable is disconnected from the ESP, the cable electrical integrity is tested from the ESP side connector by measuring the electrical voltage insulation to the mass of the cable and electrical current continuity by reading the three conductor electrical connector installed at the ESP end of the second cable section.

In some aspects, the techniques described herein relate to a system for retrieving an electrical submersible pump in a wellbore with a cable. The system includes a cable stripper that provides hydraulic seal at surface around the cable against wellbore fluids and pressure, and a coiled tubing injector head connected above the cable stripper that provides traction on the cable in the directions of upwards and downwards movements via two opposing traction chains mounted with cable specific grippers. By rotating the two opposing conveyor chains via hydraulic controls located in the unit containing the cable reel near the wellbore, pressure is applied on the cable creating a frictional force that can exceed fifty thousand pounds allowing cable movement in upwards and downwards directions and varying speeds.

The above summary presents a simplified summary in order to provide a basic understanding of some aspects of the systems and/or methods discussed herein. This summary is not an extensive overview of the systems and/or methods discussed herein. It is not intended to identify key/critical elements or to delineate the scope of such systems and/or methods. Its sole purpose is to present some concepts in a simplified form as a prelude to the more detailed description that is presented later.

### BRIEF DESCRIPTION OF THE DRAWINGS

FIG. 1 is a side plan view of an exemplary system for installing a cable deployed ESP system.

FIG. 2 is a side plan view of an exemplary ESP system in a wellbore deployed at the end of the production tubing.

FIGS. 3A to 3C are side plan views of an exemplary cable deployed system including the ESP and other downhole components of the wellhead as they are installed into the wellbore. Also shown are the well pressure control equipment (PCE) and the coiled tubing injector head.

FIG. 4 is a lateral schematic view of an exemplary cable splice installed on a first cable section and second cable section.

FIG. 5 is a cut-away view of an exemplary armored cable prior to being severed and spliced.

FIG. 6 is a side view of an exemplary second cable section after the armored cable has been severed, separating the first cable section from the second cable section.

FIG. 7 is a cross-sectional view of an exemplary embodiment of a spliced cable.

FIG. 8 is a schematic view of an exemplary alternative coupling that includes through-holes on the bottom circumferential edge.

FIG. 9A is a schematic view of an embodiment of an exemplary embodiment of a splice.

FIG. 9B is a perspective view of an exemplary swage connector.

FIG. 10 is a schematic view of an exemplary splice bypass cable clamp.

FIG. 11 is a flowchart of a detailed exemplary method for providing a splice for joining a first cable section and a second cable section of an armored power cable.

FIG. 12 is a graph showing the force over actuator displacement of the Example 1 test.

FIG. 13 is a graph showing the force over actuator displacement of the Example 2 test.

### DETAILED DESCRIPTION

Various technologies pertaining to electrical submersible pumps (ESPs) power cable termination and non-electrical splice drawings, wherein like reference numerals are used to refer to like elements throughout. In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing one or more aspects. Further, it is to be understood that functionality that is described as being carried out by certain system components may be performed by multiple components. Similarly, for instance, a component may be configured to perform functionality that is described as being carried out by multiple components.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form. Additionally, as used herein, the term “exemplary” is intended to mean serving as an illustration or example of something, and is not intended to indicate a preference. In addition, the terms “inner” and “outer” are in reference to the longest axis of the devices and systems disclosed herein. The term “fluidly coupled” means a fluid, such as oil, can flow through from one end of the area it relates to, to another. For example, X is fluidly coupled to Y, means fluid can flow through tubing or some channel or chamber from X to Y or vice versa.

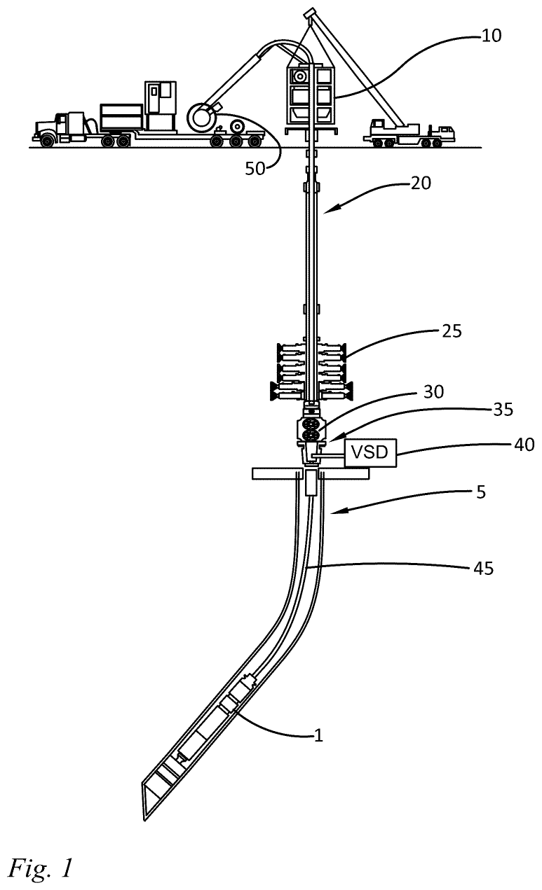

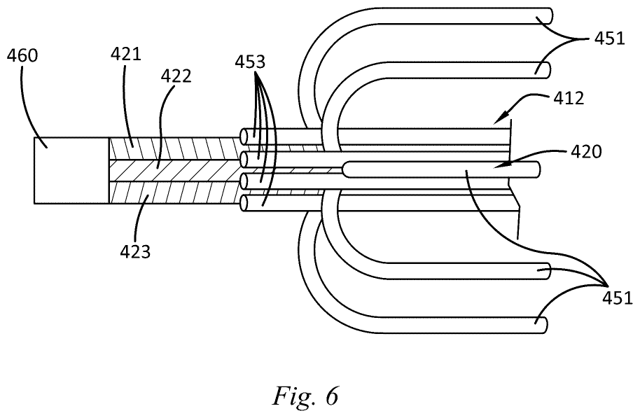

With reference to FIG. 1, an exemplary cable-deployed ESP system in a wellbore 5 with landing equipment is depicted in a schematic view. The ESP 1 is already deployed into the wellbore 5 adjacent to a pre-installed packer 15. In this example a crane hoists a pressure control equipment 10 above the wellbore 5. The pressure control equipment 10 is connected to the injector head. One or more risers 20 are coupled to the pressure control equipment 10. Inside the risers 20 are additional components of the technology disclosed more fully in FIGS. 6 to 10E. The risers 20 are connected to a blow-out preventer (BOP) which is coupled to a Christmas tree unit 30. The Christmas tree unit 30 is coupled to hanger and spool components 35. A variable speed drive (VSD) 40 is coupled to the wellbore 5 for pumping fluid from the well.

The ESP 1 is coupled to a cable 45 that runs through the wellbore 5, through the hanger and spool components 35, the Christmas tree unit 30, the risers 20 and the pressure control equipment 10 to a reel 50. The reel 50 contains the coiled cable 45. In operation the cable can be advanced (downhole) or retracted (uphole) by a feeding mechanism. In this example, the feeding mechanism (the injector head) is a set of conveyor belts that contact two sides of the cable 45 to drive it downhole or uphole.

An electrical power source (not shown) provides power to the VSD 40 and to the ESP 1 via the cable 45. Connections in the hanger and spool components 35 couple the power source to the electrical core wiring in the cable 45. The power source may, for example, drive current at 120 Amps at 5000 volts (or larger amperage for other versions of cable, e.g., up to 240 Amps or 360 Amps).

In this example, the cable 45 is a heavy-duty hybrid cable that includes a 3-phase electrical core, and is surrounded by load bearing double layered metal armors for protection and heavy-duty load bearing. The load bearing double layer armor stainless steel or other alloy metallurgy. The cable 45 can have an outer diameter, of, for example, 0.5 to 2 inches, such as 1.1 to 1.25 inches, or 1.15 to 1.25 inches, or 1.25 inches to 1.5 inches. The cable 45 may have a tensile strength of at least 25,000 lbs., e.g., 30,000 to 45,000 lbs., or 40,000 to 65,000 lbs., and may run in lengths of, for example, 2,000 to 15,000 ft, or 5,000 to 10,000 ft, or 7,000 feet.

In ESP wellbore systems that employ heavy duty cabling that includes power cabling inside it for the ESP, additional challenges are presented. Cable damage can occur if the injector head forces cable down while the ESP is not moving (e.g., stuck or already landed), or is caught on some wellhead component and cannot move down.

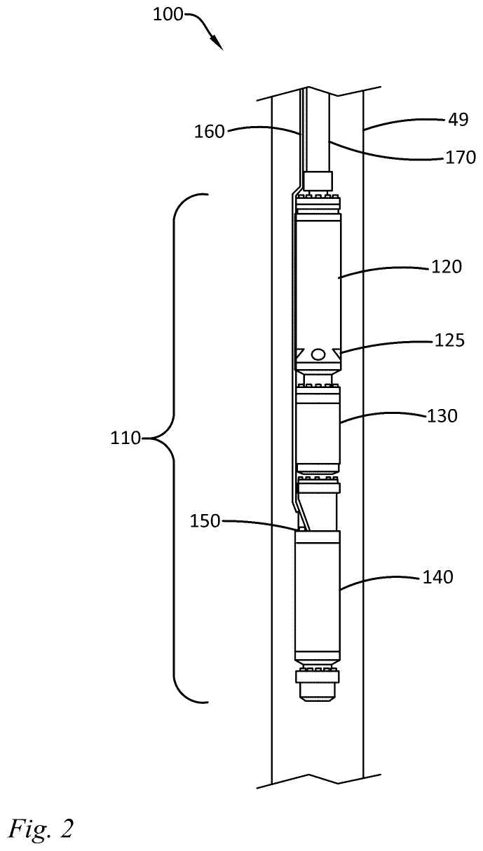

The ESP is described in more detail in FIG. 2, which shows an exemplary ESP 110 disposed within the walls of a wellbore 49. The system 100 includes an ESP 110, which comprises a pump 120, a motor protection component 130, and a motor component 140. A power connector 150 is also shown at the top of the motor component 140. The power connector 150 is attached to a power conduit cable 160, which runs up the side of the ESP 110 and continues up to the top of the wellbore 49 where it is coupled to an external power source. In other embodiments, other configurations of the various components of the ESP may also be used.

In an embodiment, the motor component 140 is at a bottom end of the ESP 110 and a top end of the motor component 140 is coupled to a bottom end of the motor protection component 130. A top end of the motor protection component 130 is coupled to the pump 120. In an embodiment the ESP 110 used in the cable deployed systems is an inverted Permanent Magnet Motor (PMM) ESO, where the pump is at the bottom with a bottom inlet and mid-section discharge, and the motor is above the pump.

An intake opening 125 is on the side of the pump 120 near the bottom end of the pump 120. Fluid from the wellbore 49 comes into the ESP from this intake opening 125 and is pumped through the pump 120 up and out of the wellbore 49 via the production tubing 170.

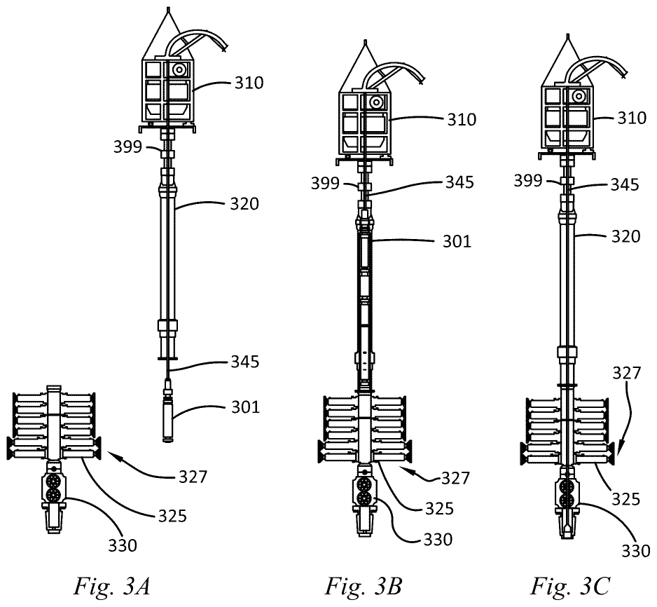

FIGS. 3A-3C show the system including the ESP 301 and other downhole components of the wellhead 327 and method as they are installed into the wellbore. In FIG. 3A, the cable 345 is advanced through the injector head 310 and through the risers 320. The risers 320, pressure control stripper 399, and injector head 310 are disconnected from the rest of the wellhead 327 to allow for the installation of the downhole components. The ESP 301 and other downhole components are then installed at the end of the cable 345 and the cable 345 and ESP 301 are retracted up into the risers 320. A crane moves the risers 320 over the wellhead 327 which is closed to wellbore fluids. The bottom terminal end of the risers 320 is then locked into place onto the top of the blow-out preventer (BOP) 325. (See FIG. 3B.) Then, the wellhead sealing valve is opened and the cable 345 is advanced downhole and the ESP 301 and other downhole equipment is lowered into the wellbore through the opened Christmas tree unit 330. (See FIG. 3C.) The ESP 301 may be dropped up to 15,000 ft, e.g., 2,000 to 10,000 ft, or 5,000 to 8,000 ft.

Two primary obstacles pose restrictions for moving a splice from the wellhead 327 to the reel 50. One obstacle is in the injector head 310, which includes a pair of opposing chain-driven sets of grippers for moving the cable 345. A set of 8-12 opposing pairs of grippers clamp onto the cable 345 and help move the cable 345 up and down as the chain-driven grippers are hydraulically driven up and down. These grippers provide tremendous force on the lateral sides of the cable, and handling of a splice with a diameter larger than the cable diameter through these grippers presents a technical challenge. It was determined that a splice that is approximately the same diameter as the cable 345 and of similar compressive strength and can provide sufficient strength to pass through the grippers of the injector head 310. Packaging a durable splice in such a form is itself an engineering challenge.

Another obstacle posing a restriction for moving a splice from the wellhead 327 to the reel 50 is the pressure control stripper 399 that is connected immediately below the injector head 310. Pressure control strippers are typically used for coiled tubing deployment with a smooth outer surface. Stranded armor power cables however have armor strands at the outer surface and require viscous grease injection at the pack-off level to ensure continuous pressure seal against wellbore fluids during the cable movement in or out of the well. Grease is typically injected at 20% higher than the encountered wellhead pressure. The pressure control stripper 399 contains one or more packoff elements (e.g., one, two, or three packoff elements) that are used to contact the cable outer armor where grease is injected to control well fluid pressures around the cable 345 as it moves in and out of the well. The packoff elements may be used to hold back fluids in the wellbore from, e.g., 0 to 10,000 pounds per square inch (psi). The cable 345 is allowed to move freely inside the pressure control stripper 399 in any direction with constant pressure viscous grease injection at the gauge or similar point.

The pack-off consists of a rubber element of the same diameter as the cable 345 inserted in the packing window around the cable and providing dynamic seal around the cable 345 assisted by grease injection to enable the cable 345 to move freely. The internal diameter of the pack-offs needs to maintain a very small gap to the cable 345 outer diameter. Thus, this also creates a restriction against anything on the cable 345 surface that is larger in size than the cable outside diameter. Since the packoff internal diameter is very close to the cable 345 diameter, and any splice required to pass through the pressure control stripper 399 needs to be of the same diameter as the cable 345 or less. Otherwise, the cable 345 may get stuck inside the pressure control stripper 399, damaging both the cable 345 and the pressure control stripper 399, potentially creating a hazardous situation.

Both injector head 310 and pressure control stripper 399 are utilized when retrieving the cable 345 and ESP 301 from the well. In order for a splice to pass through the two restrictions, it needs to be of the about the same diameter or less. It also needs to be short enough in order not to disrupt pressure control or cable movement operation, as well as it needs to be dimensioned to be spoolable on the reel 50 as the cable 345 starts being spooled on the reel 50 as it comes out from the wellbore until the ESP 301 is at surface-level.

Furthermore, in an embodiment, the cable 345 includes multiple conducting wires. It was determined that a splice, such as the non-electrical, spoolable splice disclosed herein, may contain a metallic connector that electrically shorts the multiple (e.g., three) conductors of the second cable section of the cable 345 in the wellbore. By this shorted connection When the full length of the cable is out of the well and spooled back on the reel 50, the electrical integrity of the cable 345 can be checked at the end terminating in a connection to the ESP 301. This simple check allows for confidence that the cable 345 is still operable and can be redeployed in the same wellbore without further electrical checks.

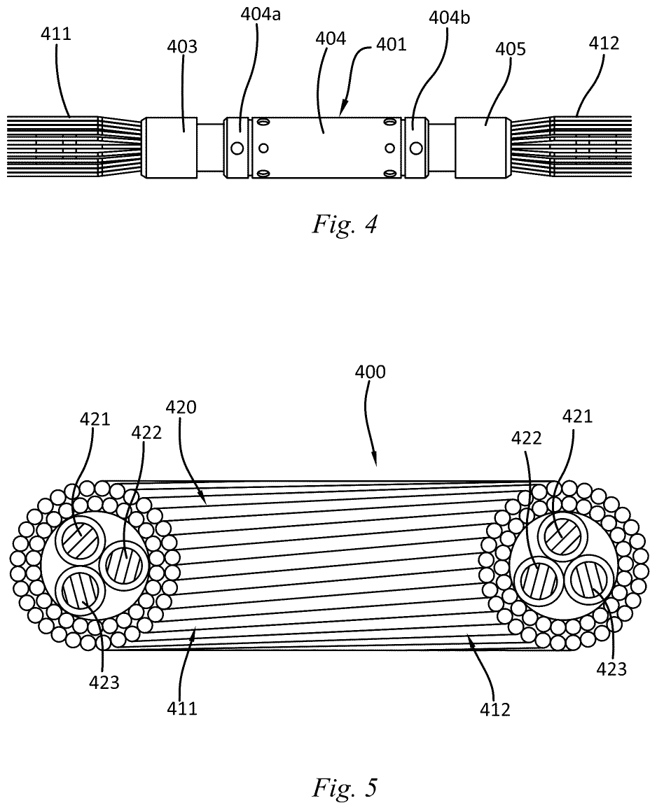

FIG. 4 is a lateral schematic view of an exemplary cable splice 401 installed on a first cable section 411 and second cable section 412. The splice 401 is joined to the terminal end of the first cable section 411 with a first coupling 403, which in this embodiment is a threaded coupling. The first coupling 403 can have either right-hand or left-hand turn threads on either an internal or external circumferential wall. The splice 401 is also joined to a terminal end of a second cable section 412, which, in use would be the cable section disposed in the wellbore. A second coupling 405 should have the opposite turn thread from the first coupling 403 to enable connection with the center connector sleeve 404 while all three components are installed in-line without having to twist either the first cable section 411 or the second cable section 412.

The center connector sleeve 404 is a cylindrical cover with threads on a first end 404a and a second end 404b. The threads on the first end 404a configured to engage with (i.e., be securely threaded into) the threads on the first coupling 403, and the threads on the second end 404b are configured to engage with (i.e., be securely threaded into) the threads on the second coupling 405. The center connector sleeve 404 is configured to be turned in one direction, either left or right to simultaneously be securely threaded into the first and second couplings 403, 405, e.g., with a right-hand turn thread on the first end 404a and a left-hand turn thread on the second end 404b, or vice-versa. The first coupling 403 and second coupling 405 comprise threads running in opposite directions from each other and the center connector sleeve 404 includes matching threads and is configured so that the center connector sleeve 404 can be turned in one direction to be simultaneously threaded into or onto the first coupling 403 and the second coupling 405.

FIG. 5 is a cut-away view of the armored cable 400 prior to being severed into the first cable section 411 and the second cable section 412 and prior to being spliced. In this example, the armored cable 400 is a heavy-duty hybrid cable that includes a 3-phase electrical core, and is surrounded by load-bearing double-layered multiple armor strands 420 for protection and heavy-duty load bearing. In an embodiment, the armored cable 400 has an electrical core (first, second, and third electrically conductive wires 421, 422, 423) and is protected by a double layered, and helically wound metallic armor (multiple armor strands 420). In an embodiment, the armored cable 400 has at least two layers and the inner and outer layer are wound in an opposite helical manner. The armor strands 420 of the armored cable 400 provide the mechanical strength to enable the complete assembly to be installed and retrieved from the well. The armored power cable disclosed herein may be classified as a wireline type cable, and is not a coiled tubing. Therefore, the cable is more flexible, and ductile and cannot be pushed in a well in the same manner as coiled tubing without damage. In an embodiment, the power cable has an average diameter of 1″ or larger, e.g., 1.25″ to 3″, or 1.5″ to 2″.

In this embodiment, first, second, and third electrically conductive wires 421, 422, 423 are disposed inside the multiple armor strands 420 of the armored cable 400. The first, second, and third electrically conductive wires 421, 422, 423 may, e.g., be made of cylindrical wire, of gauge ranging 1 AWG (American Wire Gauge) to 6 AWG diameter, such as 2 AWG to 5 AWG, or 3 AWG to 4 AWG. The wire is a conductive metal, e.g., copper, galvanized stainless steel (for non-H₂S applications), or Inconel, e.g., Inconel 825 with high Cr and Ni content for H₂S concentrations exceeding 15%. In some embodiments instead of three wires there may be, e.g., 1 to 30 electrically conductive wire strands, such as, e.g., 2 to 20, or 4 to 15 armored strands.

FIG. 6 is a view of the second cable section 412 after the armored cable 400 has been severed, separating the first cable section 411 from the second cable section 412. This terminal end of the second cable section 412 corresponds to the end that is at the surface during ESP operation. The opposite terminal end of the second cable section 412 is connected to the ESP, which would still be down the wellbore at the time the splice 401 is being prepared and installed.

In an embodiment, when service is desired, the terminal end of the second cable section 412 is prepared for splicing by peeling back a long set of strands 451 and cutting short a short set of strands 453. After stripping the insulative coating of the first, second, and third electrically conductive wires 421, 422, 423, the short-circuit connector 460, e.g., a brass connector, is installed at the terminal end of the second cable section 412. The brass connector can then be insulated with tape or other sufficient insulation to provide an electrical short circuit among the three cable conductors without touching the cable armor strands or other metal in the cable. This caps or electrically couples the first, second, and third electrically conductive wires 421, 422, 423 to provide for simple continuity testing of the full length of the second cable section 412. The electrical continuity test can be carried out post ESP retrieval and disconnection of the ESP side connector to expose the 3-conductor terminations. An electrical multimeter can be used to test the electrical continuity between pairs of cable conductors. The three pair readings should be identical and the measurement reports the total resistance of two conductor lengths through the short circuit of the 3-conductor brass short circuit connector. The insulation over the brass connector also ensures that conductor insulation from the cable armor or earth can also be tested, using a 5000 Volt mega ohmmeter tester

The cut short set of strands 453 allow for room for the splice 401 to cover the outer circumference of the spliced cable. The long set of strands 451 are peeled back to enable cutting of the short set of strands 453. In an embodiment, strands 420 that are closer to the center of the second cable section 412 or in an inner ring of strands 420 are the short set of strands 453 that are cut. The long set of strands 451 are then used (as described below) to secure the section cable section 412 to the splice 401.

In an embodiment, a spreader plate, i.e., a disk centered around the second cable section 412 can be perforated with holes configured to match the diameter of the individual long set of strands 451, to facilitate peeling back and holding the long set of strands 451 for the cutting operation on the short set of strands 453. In an embodiment, 4 to 60, 10 to 50, or 12 to 24 of the strands 420 are cut to form the short set of strands 453. In an embodiment, 5% to 60%, 15% to 50%, or 20% to 40% of the strands 420 are cut to form the short set of strands 453.

The same cutting, and peeling operation as described with reference to FIG. 6 can be done on the first cable section 411. However, the short-circuit electrical coupling does not need to be installed on the first cable section 411.

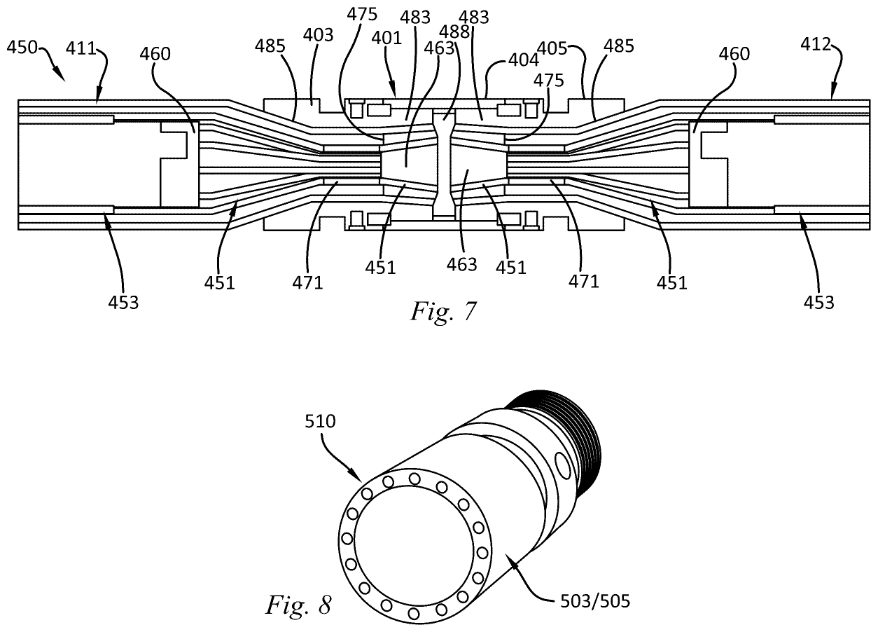

FIG. 7 is a cross-sectional view of an exemplary spliced cable section 450 comprising a first cable section 411, second cable section 412, splice 401, cylinder 471, intermediate conical wedge 475, and inner conical wedge 463.

The spliced cable section 450 is assembled by taking one of either the first or second cable sections 411, 412, with the short-circuit connector 460 as shown in FIG. 6 and feeding the long set of strands 451 into a cylinder 471 which has a diameter that is the smaller than the diameter of the first and second cable section 411, 412. The cylinder 471 may be a flexible piece of metal wrapped around the long set of strands 451 and secured together.

In an embodiment, a spreader plate is used to evenly spread out the outer layer of multiple strands 420 creating a gap with the inner layer of the multiple strands 420 into which an intermediate conical wedge 475 is punched. Once the intermediate conical wedge 475 is in place, the multiple strands 420 of the short set of strands 453 are cut-off and the remaining strands 420 are spread out and the cone insertion repeated with the inner conical wedge 463.

The first coupling 403 (if the first cable section 411 is being worked on) or second coupling 405 (if the second cable section 412 is being worked on) is placed over the outer circumference of the first and second cable section 411, 412, respectively. In an embodiment, a first inner surface 483 of the first and second coupling 403, 405 is contoured radially inward in a cone shape to promote compacting the long set of strands 453 towards a central radial axis of the splice 401.

On the terminal side of the cylinder 471 (i.e., the side terminating nearest the center of the splice 401) the long set of strands 451 is pushed radially outward by driving an inner conical wedge 463 into a central axis area. In an embodiment, a second inner surface 485 of the first and second coupling 403, 405 is contoured radially outward in a cone shape to allow for expansion the long set of strands 453 radial outwards to account for the inner conical wedge 463 in the central axis area. In an embodiment, the intermediate conical wedge 475 and inner conical wedge 463 are driven inside the splice 401.

After one of the first or second cable sections 411, 412 is prepared as discussed above (or simultaneously with), the opposite end is prepared in the same manner the. (Although the short-circuit connector 460 does not need to be installed on the first cable section 411.)

Once both first and second cable sections 411, 412 are prepared, the center connector sleeve 404 is inserted between the first and second couplings 403, 405. In an embodiment the center connector sleeve 404 is threaded onto both the first and second couplings 403, 405 by turning in one direction. A small middle open-area 488 is between the inner conical wedge 463 of the first and second cable sections 411, 412. In an embodiment this middle open-area 488 is small enough in axial dimension to prevent the inner conical wedge 463 from moving enough to dislodge the impacted long set of strands 451.

In an embodiment, once assembled, the first and second couplings 403, 405 and the center connector sleeve 404 are torque-locked using lock or grub screws inserted through the threaded holes available at either end of the threaded connector sleeve. This allows for a rigid, torque-locked assembly preventing the accidental backing of any of the threads in the assembly. The splice 401 can have an outer diameter of 0.5 to 2 inches, such as 1.1 to 1.25 inches.

The splice 401 can have a length of 3 to 7 inches, such as 4 to 6.8 inches, or 4.2 to 6.5 inches. The splice 401 may have a tensile strength of at least 15,000 lbs., e.g. 16,000 to 35,000, or 18,000 to 21,000 lbs. Overall splice 401 outer diameter is measured to ensure it is the about the same or slightly less than the first and second cable section outer diameters, e.g., 0.0% to −5% the same outer diameter, −0.1 to −3%, or −0.15% to −1%. (Negative percentages mean the swage outer diameter is less than the cable section outer diameters, and overall swage diameter means the largest diameter of the swage is the measured location.)

The first and/or second cable sections 411, 412 between the first and second couplings 403, 405 and the short-circuit connector 460 can be filled with epoxy and covered with electrical tape. The cut-off multiple strands 420 can be tucked inside the volume created by the gap between the short-circuit connector 460 and the first and second couplings 403, 405. This is done prevent cut strands from the short set of strands 453 from protruding outside the diameter of the first or second cable sections 411, 412 to become caught inside the pressure control stripper 399 or the injector head 310 restrictions, causing major cable damage and a lengthy and risky recovery process.

In another embodiment, instead of using threads, a quick connect type axial coupling can be used, wherein a holding ring is pulled axially on a female side, opening a retainer for entry of the opposing male side. After entry, the retainer ring is pushed back into place, e.g., by spring loading, and in an embodiment, this ring can be locked into place with a bolt or screw. In an embodiment, a standard slickline type UNF quick connect can be used, a quick-connect with knuckle joint and/or a swivel head joint can also be used.

FIG. 8 shows an alternative first or second coupling 503, 505 that includes through-holes 510 on the bottom circumferential edge.

These through-holes 510 are designed to fit the long set of strands 453, which can be threaded through to allow for more room inside the splice 501 and provide a secure location for the cut multiple strands. Instead of feeding all the long set of strands 453 into a central area of the splice 501, at least some of the long set of strands 453 are fed into the through-holes 510. This design also provides another way to prevent the long set of strands 453 from accidentally sticking outside of the splice 401 and getting caught inside the restrictions during the movement of the first and second cable sections 411, 412 through such restrictions.

In one instance, excessive pull on the cable and the splice 501 may lead to a given stretching of the cable. The strands that enter the through-holes 510 do not carry load, hence will not stretch by the same amount under force. However, based on maximum pull expected in a typical well installation, the stretching of the load-bearing strands will not exceed a cable stretch exceeding the first or second coupling 503, 505 housing length, thereby ensuring the non-load bearing strands remain inside the through-holes 510 at all times.

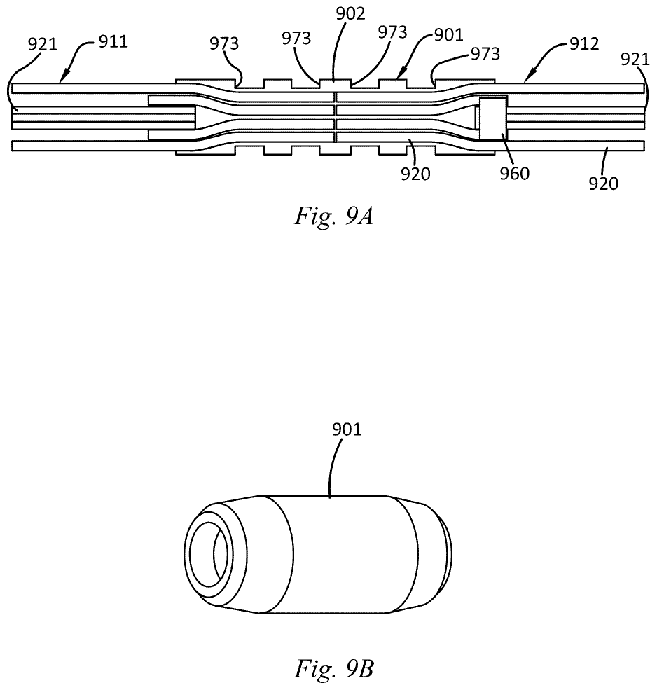

In another embodiment, a simplified version of the splice 901 is presented in FIGS. 9A and 9B, which is a schematic representation of the spliced cable. Here, instead of using mechanical terminations and a center connector sleeve like in FIGS. 4-8, the multiple armor strands 920 are spread open, exposing the electrical core wiring 921. An end portion of the electrical core wiring 921 is cut and removed from both first and second cable sections 911, 912. Then a short-circuit connector 960 is installed on the second cable section 912. Then all or substantially all (e.g., 90% or more) of the multiple strands 920 are cut to a predetermined approximately uniform length extending past the end of the electrical core wiring 921 and short-circuit connector 960 (if the multiple strands 920 are not already of approximately uniform length). This length may be, e.g., 1.5 to 4 inches, such as, e.g., 2 to 3.5 inches, or 2.75 to 3.25 inches extending past the terminal end of the short-circuit connector 960. These are analogous or the same as the long set of strands 451 described above. The multiple strands 920 are then regrouped and packed into a small bundle.

A swage connector 902, which may initially be slightly larger in diameter than the cable section 912 outside diameter, is then installed over the multiple strands 920 from both the first and second cable section 911, 912. This can be accomplished by feeding the multiple strands of the second cable section 912 through the swage connector 902 and then feeding the multiple strands 920 of the first cable section 911 through an opposite end of the swage connector 902.

The first and second cable sections 911 and 912 are then pushed together until the cable ends meet approximately half way in the swage connector 902. The multiple armor strands 920 of the first cable section 911 received within the swage connector 902 are of about equal length to the multiple armor strands 920 of the second cable section 912 received within the swage connector 902. About equal meaning plus or minus 10%, e.g., plus or minus 5%, or plus or minus 2%. Length of the received strands may be determined by measuring the longest strand of the multiple strands 920 from its insertion point in the swage connector 902 to its terminal end.

A swaging tool (e.g., hydraulic swaging tool) may be utilized to compress (swage) the swage connector 902 to the same OD as the first and second cable sections 911, 912 clamping down, providing a firm hold of the multiple strands 920 and creating the splice 901. Swage crimps 973 are shown in FIG. 9A on the outer surface of the swage connector 902. FIG. 9B shows an exterior perspective view of the swage connector 902. Overall swage outer diameter is measured to ensure it is the about the same or slightly less than the first and second cable section outer diameters, e.g., 0.0% to −5% the same outer diameter, −0.1 to −3%, or −0.15% to −1%. (Negative percentages mean the swage outer diameter is less than the cable section outer diameters, and overall swage diameter means the largest diameter of the swage is the measured location.)

This embodiment of the splice 901 can utilize all the inner and outer multiple strands 920 and takes a fraction of the time to assemble. However, it relies on the grip created by swaging to ensure splice strength, so depending on the quality of the swaging, may not provide as much pull strength as first and second embodiments discussed above. In addition, pull strength can be affected by whether equal lengths of each side are inserted. In addition, specialized swaging tools are needed at the wellsite to carry out proper swaging on top of the work tower scaffolding installed over the well.

Due to cut-off armor strands at the splice, splice tensile strength is reduced to below the cable tensile strength. However, by design, residual splice strength exceeds total forces needed to pull full wellbore cable weight, ESP weight, and wellbore frictional forces on cable and ESP. The splice needs to carry the forementioned forces to a distance of a few dozen feet only, until the splice passes the injector head 310. Above the injector head 310 and on the side of the reel 50, the cable load is decreased to a nominal reel spooling load. Splice tensile loading is thus reduced from that point restoring full cable or nearly full tensile strength to continue pulling cable 345 and ESP 110 out of the wellbore.

In one eventuality it is deemed the forces needed to release the ESP 110 from the latch point in the wellbore are higher than the normal forces of the cable 345, ESP 110 weight and the frictional forces on the cable 345 and ESP 110. In this case, the splice tensile strength may not be sufficient to overcome the required additional force. A splice bypass cable clamp 951 can be utilized in such cases.

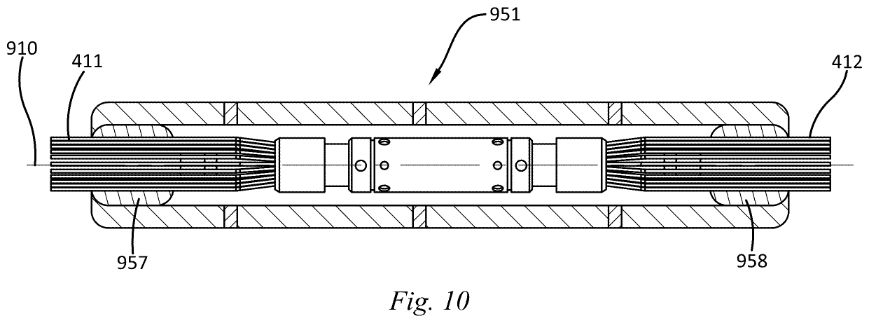

FIG. 10 is a schematic view of a splice bypass cable clamp 951 installed over a splice (e.g., splice 401, 501, 901) for providing tensile strength exceeding that of the splice and relieving the full load from the splice. The splice bypass cable clamp 951 comprises split-cylinder housings (e.g., two hemispherical housings separated along the axis 950) with first and second clamp inserts 957, 958 on either end of the splice bypass cable clamp 951 that are configured to contact and clamp down on the first and second cable sections 411, 412 and tightened shut by multiple lock screws. The first and second clamp inserts may be made of, e.g., brass. The first and second clamp inserts 957, 958 can be threaded into the half sleeves with retaining screws, and a set of high tensile screws to connect and lock the intact sections of the cable to the half sleeves through the brass inserts.

The outer diameter of the splice bypass cable clamp 951 is larger than the outer diameter for the first and second cable sections 411, 412. The splice bypass cable clamp 951 is configured to be a temporary installation to relieve the load from the splice (e.g., splice 401, 501, 901) in the event the overall loading on the splice exceeds the splice tensile rating. The splice bypass cable clamp 951 is removed once the ESP is unlatched from its latch point in the wellbore. Then when forces required to safely retrieve the wellbore cable 345 and the ESP are back to normal, the splice bypass cable clamp 951 can be removed and the splice can handle the normal forces itself.

Referring back to FIGS. 1-3C, the cable needs to be spliced to allow a complete retrieval safely from the wellbore including the ESP 110 attached to the cable 345. The coiled tubing injector head 310 is used to move thousands of feet of cable 345 out of the wellhead 327 during the retrieval process. The pressure control stripper 399 and other pressure control equipment are at surface between the injector head 310 and the wellhead 327 to provide a dynamic pressure seal against the cable 345 exiting the wellhead 327 which may contain well fluids under pressure. The pressure control equipment ensures the well fluids are not accidentally released to the atmosphere above the wellhead 327 leading potentially to fire hazards and wellhead destruction.

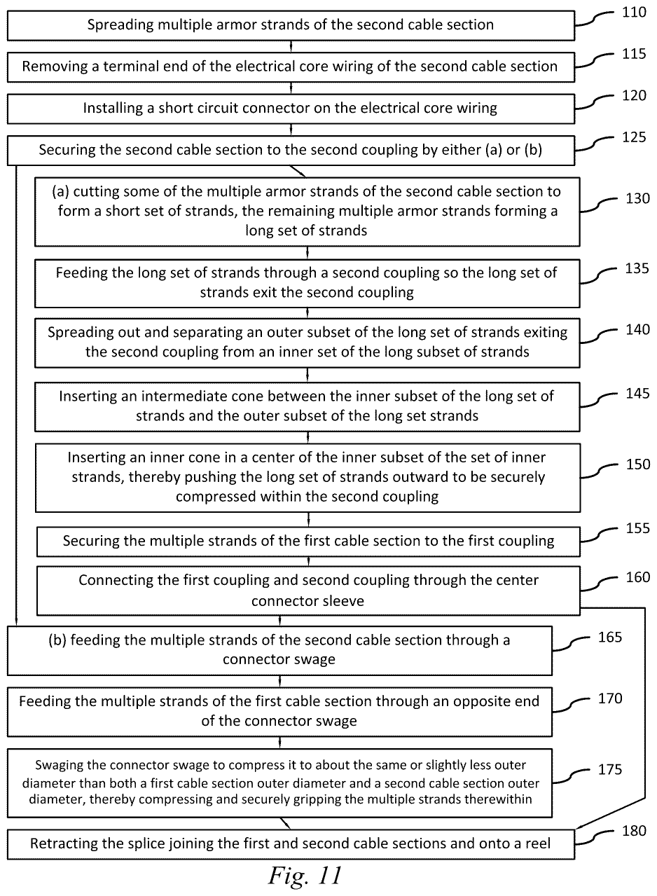

While the process has been described in part with reference to the Figures illustrating the device and system above, FIG. 11 is a flow chart showing an exemplary method of retrieving an armored cable for an ESP, checking it for electrically continuity, splicing the cable, and then redeploying the spliced cable.

FIG. 11 is a flowchart of a detailed example method for providing a splice comprising a first coupling, a second coupling, and a center connector sleeve, to join a first cable section and a second cable section of an armored power cable including multiple armor strands and electrical core wiring. As discussed herein, the second cable section is considered to be the one that is coupled to the ESP and is down in the wellbore when the method is commenced.

The method includes at step 1110, spreading multiple armor strands of the second cable section. This can be done manually or could be automated. A spreader disk as mentioned above may be used. The method further includes at step 1115, removing a terminal end of the electrical core wiring of the second cable section, and at step 1120, installing a short-circuit connector on the electrical core wiring. This step may also include stripping a short portion of wire insulation and taping around the short-circuit connector.

The first cable section can also have a terminal end of the electrical core wiring removed, but a short-circuit connector is unnecessary since the electrical continuity of the first cable section, which is already out of the wellbore and on a reel, can already be easily tested.

The method further includes, at step 1125, securing the second cable section to the second coupling by either of substeps (a) or (b) as defined below.

In substep (a), step 1130, the operator cuts some of the multiple armor strands of the second cable section to form a short set of strands, the remaining multiple armor strands forming a long set of strands. Then, at step 1135, the operator feeds the long set of strands through the second coupling so the long set of strands exit the second coupling. If needed, the short set of strands can be secured to the center of the cable section to prevent the ends of the short set of strands from extending out further than the cable section outer diameter.

At step 1140, the method continues with spreading out and separating an outer subset of the long set of strands exiting the second coupling from an inner set of the long subset of strands, and at step 1145, inserting an intermediate cone between the inner subset of the long set of strands and the outer subset of the long set strands.

At step 1150, the operator inserts an inner cone in a center of the inner subset of the set of inner strands, thereby pushing the long set of strands outward to be securely compressed within the second coupling. Then at step 1155, the operator secures the multiple strands of the first cable section to the first coupling.

The operator can also facilitate a tight wrapping of the multiple strands for fitting through the interior of the first or second couplings, or the center connector sleeve by wrapping the remaining strands with one or more metal hose clamps. Furthermore, to facilitate a clean finished product the ends of the short or long set of strands can further be trimmed to be flush with the end of the first and/or second coupling.

At step 1160, the operator connects the first coupling and second coupling through the center connector sleeve, wherein each of the first coupling, second coupling, and center connector have same or slightly smaller outer diameter than both a first cable section outer diameter and a second cable section outer diameter. This same or similar diameter feature enables the splice to fit restrictions mentioned above.

In addition, the operator can install and tighten two or more locking screws in the threaded holes at each end of the cylindrical connector sleeve until the locking screws are flush with the cylindrical connector sleeve housing. Optionally, a locking compound liquid cab be used to promote no unintentional loosening or backing off of the locking screws during cable movement.

A more general description corresponding to substeps (a) comprises: inserting at least a portion of the multiple armor strands of the armored power cable of the first cable section into the first coupling; inserting at least a portion of the multiple armor strands of the second cable section into the second coupling; inserting an intermediate conical wedge and an inner conical wedge into the multiple armor strands of the first cable section and second cable section; and joining the first coupling and the second coupling together with the center connector sleeve.

Substeps (b) commence at step 1165, and include feeding the multiple strands of the second cable section through a swage connector. At step 1170, the operator feeds the multiple strands of the first cable section through an opposite end of the swage connector. Then at step 1175, the method continues with swaging the swage connector to compress it to about the same or slightly smaller outer diameter than both a first cable section outer diameter and a second cable section outer diameter, thereby compressing and securely gripping the multiple strands therewithin. A specialized swaging tool corresponding to the dimensions of the swage connector and configured to compress the swage to a maximum diameter no greater than about the diameter of the first and second cable sections.

In use, once the splice is installed, the operator can retract the splice and the first and second cable sections onto a reel as the ESP is retrieved from the wellbore. This involves moving the splice through the pressure control stripper and/or injector head.

Once either embodiment of the cable non-electrical splice is installed, the spliced cable is picked-up by the injector head, and the splice is tested mechanically against the calculated forces needed to safely lift the cable and the ESP from the wellbore and onto the coiled tubing reel.

In an embodiment, the strength of the splice is tested by first using the coiled tubing injector head until the cable is straight in a vertical position. Then slowly the load on the spliced cable is increased until the desired load is achieved. The load can be held holding for short time period, e.g., 1 to 10 minutes or 3 to 5 minutes to insure the cable splice can hold the load safely.

If desired, the splice bypass cable clamp discussed above can be used to fortify the splice for a short lift and/or hold to test the forces on the splice and cable. This can be used in the event that total calculated load forces on the splice exceed the tensile strength of the splice. This may be useful if there are any unanticipated or unknown forces acting on the ESP or cable, e.g., if there are any obstructions in the well.

If deemed safe for further retrieval, the clamp can be removed and the retrieval operation can commence. Once the splice is in proper position on the reel, with one or more additional cable wraps on the reel next to or on top of splice, then additional strength will be imparted to the splice from the additional friction of the cable adjacent the splice.

Prior to spooling the splice up, the pressure control equipment may be closed, and the wellhead pressure equalized, then the operator can open the well crown valve and all cable holding apparatus in the pressure control equipment. Then the splice and cable can be reeled up slowly while monitoring the load on the injector head.

Once the ESP arrives at the surface at the top of the wellbore, it can be serviced and the second cable section (the one that was removed from the wellbore) can be tested for continuity and insulation as described above. If the second cable section passes the electrical tests it can be redeployed with confidence that it will still be operable.

### EXAMPLES

### Example 1

A spoolable splice attached as described in the Figures above to a first and second section of armored cable. Calculated yield strength of the splice was tested by performing a tensile test to failure. By installing a cable sample in a test frame for testing up to 100,000 lbf and 7-7.5 ft total displacement. A length change of the cable was determined during the test via actuator displacement.

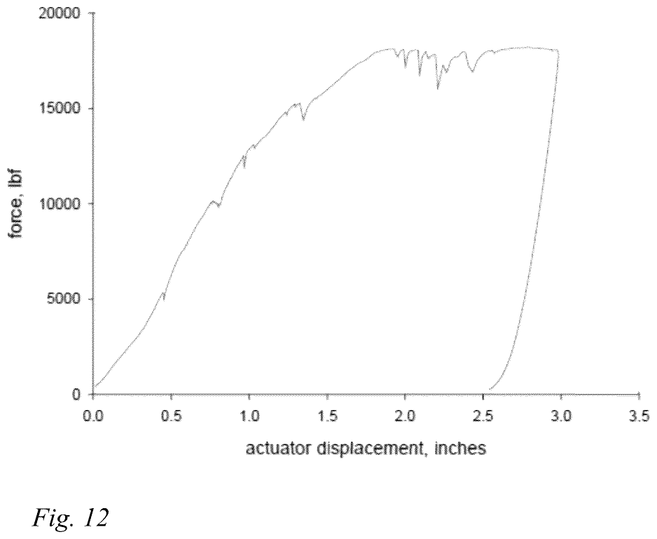

In Example 1, force was applied to the spoolable splice at 5 kip, 10 kip, and 18 kip, and the force was held for 1 minute during each increment and then released back to zero after 18 kip. The calculated yield strength of the spoolable splice was 16.9 kip. To verify the splice would hold at the yield force of 6% greater was applied (18 kip). Example 1 passed the test with the given force. FIG. 12 is a force over actuator displacement graph of the Example 1 test. FIG. 12 shows fluctuation at 18 kip because the applied force was beyond the yield strength.

### Example 2

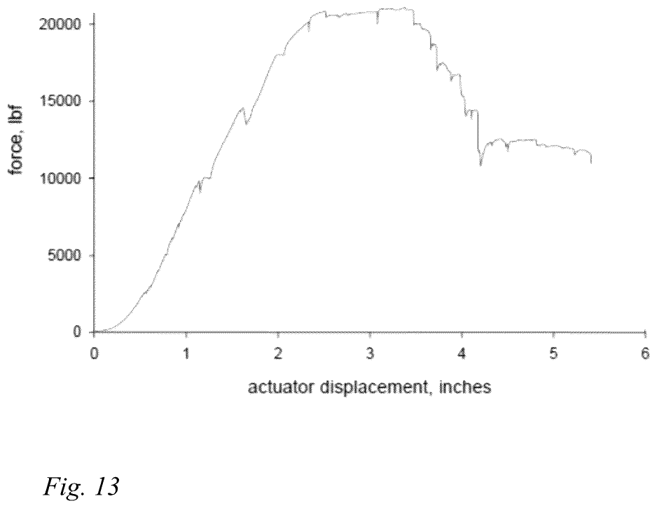

Another spoolable splice was attached as described in the Figures above to a first and second section of armored cable. The same testing as described in Example 1 was performed, except, after the 18 kip force, additional force was applied until breakage occurred. FIG. 13 shows the force over actuator displacement graph of the Example 2 test. The maximum tensile force sustained by the Example 2 splice was 21,110 lbf prior to break. The yield point was typical of upper limits of allowable loading on a standard cable or conventional splice.

What has been described above includes examples of one or more embodiments. It is, of course, not possible to describe every conceivable modification and alteration of the above devices or methodologies for purposes of describing the aforementioned aspects, but one of ordinary skill in the art can recognize that many further modifications and permutations of various aspects are possible. Accordingly, the described aspects are intended to embrace all such alterations, modifications, and variations that fall within the spirit and scope of the appended claims. Furthermore, to the extent that the term “includes” is used in either the details description or the claims, such term is intended to be inclusive in a manner similar to the term “comprising” as “comprising” is interpreted when employed as a transitional word in a claim. The term “consisting essentially” as used herein means the specified materials or steps and those that do not materially affect the basic and novel characteristics of the material or method. If not specified above, the properties mentioned herein may be determined by applicable ASTM standards, or if an ASTM standard does not exist for the property, the most commonly used standard known by those of skill in the art may be used. The articles “a,” “an,” and “the,” should be interpreted to mean “one or more” unless the context indicates the contrary.

What is claimed is:

1. A splice for joining a first and second section of an armored power cable including multiple armor strands and electrical core wiring, comprising:
a first coupling, a second coupling, and a center connector sleeve;
the first coupling and second coupling configured to receive at least a portion of the multiple armor strands of the armored power cable with an end portion of the electrical core wiring removed from a terminal end of the first and section sections;
the first coupling including an intermediate conical wedge and an inner conical wedge and being configured so as to retain at least a portion of multiple armor strands from the first cable section between an inner surface of the first coupling and an outer surface of the intermediate conical wedge; and to retain at least another portion of the multiple armor strands between an inner surface of the intermediate conical wedge and an outer surface of the inner conical wedge;
the first coupling and the second coupling being joined together with the center connector sleeve
an outer diameter of the first coupling, the second coupling, and the center connector sleeve is the same or slightly less than an outer diameter of the first section and second section.

2. The splice of claim 1, wherein the second coupling includes a second intermediate conical wedge, and a second inner conical wedge, and is configured so as to retain at least a portion of multiple armor strands of the second cable section between an inner surface of the second coupling and an outer surface of the second intermediate conical wedge; and to retain at least another portion of the multiple armor strands of the second cable section between an inner surface of the second intermediate conical wedge and an outer surface of the second inner conical wedge.

3. The splice of claim 1, further comprising a short-circuit connector coupled to a terminal end of the electrical core wiring of at least one of the first or second sections of armored power cable.

4. The splice of claim 3, wherein the short-circuit connector connects each of a first electrically conductive wire, a second electrically conductive wire, and a third electrically conductive wire in the electrical core wire.

5. The splice of claim 1, wherein the first coupling and second coupling comprise threads running in opposite directions from each other and the center connector sleeve includes matching threads and is configured so that the center connector sleeve can be turned in one direction to be simultaneously threaded into or onto the first coupling and the second coupling.

6. The splice of claim 1, wherein the multiple armor strands comprise a long set of strands and a short set of strands, and the first coupling and second coupling are configured to receive the long set of strands but not the short set of strands.

7. The splice of claim 1, wherein at least one of the first coupling and second coupling includes through-holes in a bottom circumferential edge and at least a portion of the multiple armor strands are inserted into the through-holes.

8. The splice of claim 1, wherein the first coupling, second coupling, and center connector sleeve include a threaded hole for receiving a lock or grub screw.

9. A splice for joining a first and second section of an armored power cable including multiple armor strands and electrical core wiring, comprising:
a swage connector;
the swage connector configured to receive at least a portion of the multiple armor strands of the armored power cable with an end portion of the electrical core wiring removed from a terminal end of the first and second sections;
the multiple armor strands of the first section received within the swage connector of the armored power cable being of about equal length to the multiple armor strands of the second section received within the swage connector;
the swage connector compressed to clamp and hold the multiple armor strands of the first section and second section;
an outer diameter of the swage connector is the same or slightly less than the outer diameter of the first section and second section.

10. The splice of claim 9, wherein the swage connector has a length of 3 or 7 inches.

11. The splice of claim 9, wherein the swage connector comprises swage crimps on an outer surface thereof.

12. A method for providing a splice comprising a first coupling, a second coupling, and a center connector sleeve, to join a first cable section and a second cable section of an armored power cable including multiple armor strands and electrical core wiring, the method comprising:
spreading multiple armor strands of the second cable section;
removing a terminal end of the electrical core wiring of the second cable section;
installing a short circuit connector on the electrical core wiring; and
securing the second cable section to the second coupling by either substeps (a) or (b):
(a) inserting at least a portion of the multiple armor strands of the armored power cable of the first cable section into the first coupling;
inserting at least a portion of the multiple armor strands of the second cable section into the second coupling;
inserting an intermediate conical wedge and an inner conical wedge into the multiple armor strands of the first cable section and second cable section;
joining the first coupling and the second coupling together with the center connector sleeve; or
(b) feeding the multiple strands of the second cable section through a swage connector;
feeding the multiple strands of the first cable section through an opposite end of the swage connector;
swaging the swage connector to compress it to about the same or slightly smaller outer diameter than both a first cable section outer diameter and a second cable section outer diameter, thereby compressing and securely gripping the multiple strands therewithin.

13. The method of claim 12, further comprising retracting the splice and the first and second cable sections onto a reel.

14. The method of claim 13, wherein an electrical submersible pump is coupled to an end of the second cable section.

15. The method of claim 13, wherein retracting the splice and the first and second cable sections onto the reel includes moving the splice past a pressure control stripper, an injector head, or both.

16. The method of claim 14, further comprising retracting the splice and the first and second cable sections onto the reel until an electrical submersible pump at an end of the second cable section is retrieved at a top of a wellbore.

17. The method of claim 16, wherein an electrical continuity test is performed on the second cable section at or near the electrical submersible pump.

18. The method of claim 17, wherein if the second cable section is determined to be electrically operable, then the splice, the second cable, and the electrical submersible pump is redeployed down the wellbore.

19. The method of claim 12, wherein substeps (a) are performed and the method further comprises:
cutting some of the multiple armor strands of the second cable section to form a short set of strands, the multiple armor strands that are not cut forming a long set of strands;
feeding the long set of strands through a second coupling so the long set of strands exit the second coupling;
spreading out and separating an outer subset of the long set of strands exiting the second coupling from an inner set of the long subset of strands;
inserting an intermediate cone between the inner subset of the long set of strands and the outer subset of the long set of strands;
inserting an inner cone in a center of the inner subset of the set of inner strands, thereby pushing the long set of strands outward to be securely compressed within the second coupling;
securing the multiple strands of the first cable section to the first coupling; and
connecting the first coupling and second coupling through the center connector sleeve wherein each of the first coupling, second coupling, and center connector have same or slightly smaller outer diameter than both a first cable section outer diameter and a second cable section outer diameter.

20. The method of claim 12, wherein at least one of the first coupling and second coupling includes through-holes in a bottom circumferential edge and at least a portion of the multiple armor strands are inserted into the through-holes.
